(19) United States
(12) Patent Application Publication
(10) Pub. No.: US 2009/0210175 A1
(43) Pub. Date: Aug. 20, 2009

(54) Ultrasonic Leak Test System and Method

(76) Inventor: Greg J. Bilpuch, Lake Orion, MI (US)

Correspondence Address: LANIER FORD SHAVER & PAYNE P.C., P O BOX 2087, HUNTSVILLE, AL, 35804-2087, US

(21) Appl. No.: 12/333,088

(22) Filed: Dec. 11, 2008

Related U.S. Application Data
(60) Provisional application No. 61/007,123, filed on Dec. 11, 2007.

(51) Int. Cl. G01M 3/24

(52) U.S. Cl. 702/51

(57) ABSTRACT

A leak detection system has a test frame for receiving a vehicle. An ultrasonic transmitter is placed within the vehicle under test. One or more robotic arms are disposed within the test frame and comprise ultrasonic receivers which detect ultrasonic energy emitting from the vehicle under test. The robotic arms connect to the ceiling of the test frame and move the ultrasonic receivers along the areas of the vehicle in which leakage may be expected to occur. A method in accordance with an embodiment of the present disclosure comprises the steps of placing an ultrasonic transmitter into a vehicle, scanning a vehicle identification number of a vehicle under test, placing an ultrasonic transmitter into the vehicle under test, moving the vehicle under test into a test frame, verifying a proper orientation of the vehicle for testing, activating robotically-controlled ultrasonic receivers, collecting leak test data, storing leak test data received from the ultrasonic receivers, and comparing the leak test data received to a normal leak test signature.

### CROSS REFERENCE TO RELATED APPLICATION

This application claims priority to U.S. Provisional Application No. 61/007,123, entitled “Ultrasonic Leak Test System and Method,” filed on Dec. 11, 2007, which is incorporated herein by reference.

### FIELD OF INVENTION

The present invention relates generally to the field of leak detection, and specifically to a system and method for ultrasonic leak detection.

### BACKGROUND AND SUMMARY

A system in accordance with an embodiment of the present disclosure comprises a test frame which receives a vehicle under test. An ultrasonic transmitter is placed within the vehicle under test. One or more robotic arms are disposed within the test frame and comprise ultrasonic receivers which detect ultrasonic energy emitting from the vehicle under test. The robotic arms connect to the “ceiling” of the test frame for convenience in stowing out of the way of the vehicle under test and of humans in the test area, and also for ease in accessing the topmost and centermost areas of the vehicle.

A method in accordance with an embodiment of the present disclosure comprises the steps of placing an ultrasonic transmitter into a vehicle, scanning a vehicle identification number of a vehicle under test, placing an ultrasonic transmitter into the vehicle under test, moving the vehicle under test into a test frame, verifying a proper orientation of the vehicle for testing, activating robotically-controlled ultrasonic receivers, collecting leak test data, storing leak test data received from the ultrasonic receivers, and comparing the leak test data received to a normal leak test signature.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 is an overhead perspective view of a system according to an embodiment of the present disclosure.

FIG. 2 is a front perspective pictorial view of an exemplary frame for the system illustrated in FIG. 1.

FIG. 3 is a perspective view of an exemplary robot of the system illustrated in FIG. 1.

FIG. 4 is a perspective view of another robot of the system illustrated in FIG. 1.

FIG. 5 illustrates a transmitter installed in a vehicle under test in a system according to an embodiment of the present disclosure.

FIG. 6 illustrates an ultrasonic signal emitting from a vehicle under test in a system according to an embodiment of the present disclosure.

FIG. 7 is a block diagram of an exemplary robot controller of an embodiment system depicted in FIG. 1.

FIG. 8 is a flowchart depicting exemplary architecture and functionality of an embodiment the system depicted in FIG. 1.

### DETAILED DESCRIPTION

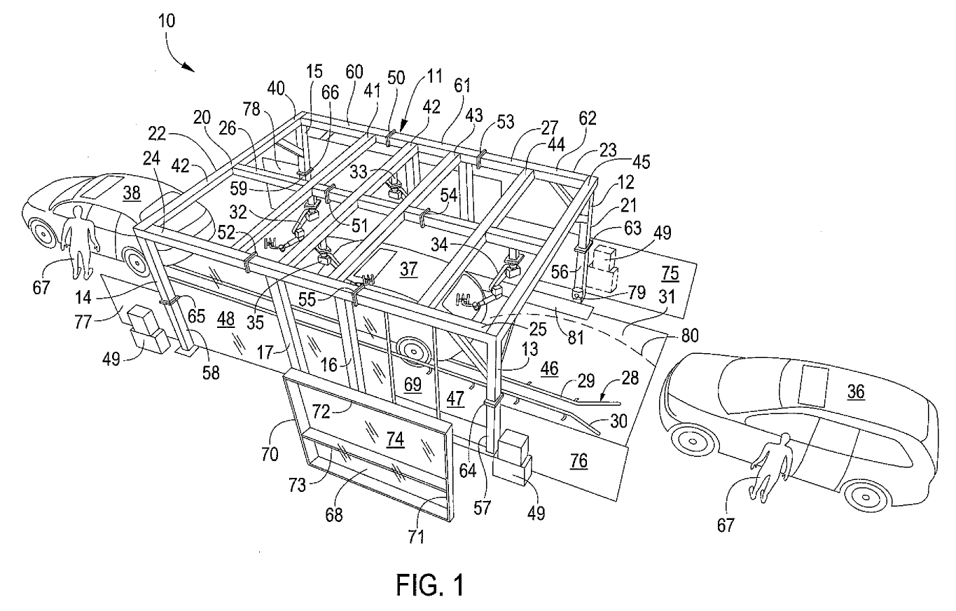

FIG. 1 illustrates a system 10 in accordance with an exemplary embodiment of the present disclosure. The system 10 comprises a generally rectangular frame 11 having a top side 20, a substantially open front side 21, a substantially open rear side 22, and right and left sides 23 and 24, respectively.

The frame 11 is formed with four (4) substantially vertical corner posts 12-15 and a plurality of vertical supports 16-19. More or fewer posts and/or supports may be used, depending upon the desired configuration of the frame 11.

The top side 20 of the frame 11 comprises substantially horizontal longitudinal support beams 25-27, wherein beam 25 is the leftmost horizontal longitudinal beam, beam 26 is a central horizontal longitudinal beam, and beam 27 is the rightmost horizontal longitudinal beam. The top side 20 of the frame 11 further comprises substantially horizontal transverse support beams 40-45, which provide transverse support to the top side 20 of the frame 11, as illustrated in FIG. 1. More or fewer transverse support beams may be used depending upon the desired configuration and support of the frame 11. The frame supports, beams, and posts may be fabricated from any of a number of rigid materials, such as aluminum, steel, or composite material.

The frame 11 supports a plurality of robots 32-35, which connect to the underside (not shown) of the longitudinal support beams 25-27, and/or to the horizontal transverse support beams 40-45. Robots 32-35 perform the ultrasonic testing of vehicles 36-38, as further discussed herein. Although the illustrated embodiment shows four (4) robots 32-35, more or fewer robots may be used depending upon the size and configuration of the vehicle under test, as well as other test parameters.

The frame 11 suspends the robots 32-35 over vehicles 36-38 during individual leak testing of the vehicles 36-38. Therefore, the frame 11 is sized and shaped to accommodate whatever vehicle is desired to be tested. Although FIG. 1 illustrates a passenger-type van as vehicles 36-38, other types of vehicles, such as Army tanks, armored cars, and trucks (not shown) could alternatively be accommodated which is discussed further herein.

FIG. 1 illustrates vehicle 37 in position for testing, while vehicle 36 is next in line for testing and vehicle 38 has completed its testing. The frame 11 thus accommodates one vehicle under test and allows for vehicles to be driven into a test area 31 and underneath the frame 11 at the front side 21 and out from beneath the frame 11 and out of the test area 31 at the rear side 22. For purposes of this disclosure, the test area 31 encompasses the area that begins where the vehicle under test enters the frame 11 and extends to where the vehicle leaves the frame 11.

A track 28, comprised of a right guide 29 and a left guide 30, receives the left wheels (not shown) of the vehicle 37 and guides the vehicle 37 within proximity to the robots 32-35. In this regard, the vehicle is positioned so that the robots can be moved close enough to any seal (not shown) of the automobile that has a potential for leaking.

The left wheels remain in contact with a floor 46 and are bounded by the guides 29 and 30. A wheel stop (not shown), which may be in the form of a raised “bump” in the floor 46 within the guides 29 and 30, provides the vehicle's driver (not shown) with a physical indication that the vehicle is in the correct position for testing. In some embodiments, the frame 11 may be disposed over a standard assembly line conveyor (not shown) for automobiles. In those embodiments, the assembly line conveyor may be programmed to stop when the vehicle 37 is in the proper orientation without the use of track 28.

The left side 24 of the frame 11 may further comprise wall panels 47, which connect to the outermost supports, beams and/or posts (such as post 14, beam 25, post 13, and supports 16 and 17) and provide a barrier on left side 24 of the frame 11. Similarly, the right side 23 of the frame 11 may further comprise wall panels 47, which connect to the outermost supports, beams and/or posts (such as post 12, beam 27, post 15, and supports 18 and 19) and provide a barrier on right side 23 of the frame 11. In one embodiment of the system 10, the wall panels 47 are fabricated from fiberglass. Any of a number of other materials could be used for the wall panels 47, such as plastic, composite, wood, fabric, or the like.

In some embodiments of the system 10, additional protection may be desired to ensure the safety of persons (not shown) who may be in the vicinity in the unlikely event that one or more of the robots 32-35 malfunctions and strikes the wall panels 47. This additional protection may be in the form of one or more shields 48 comprised of a strong rigid material (such as metal) that is attached to the sides 23 and 24 of the frame 11.

One or more robot controllers 49 may be disposed on the frame 11. The controllers 49 control the robots 32-35. The controllers 49 may comprise hardware, software, or a combination thereof for controlling the robots 32-35 in order to collect test data corresponding to the effectiveness of the seals, i.e., whether there exist leaks and the grossness of the leak.

The frame 11 comprises flanged joints 50-55 wherein individual frame segments 60-62 are bolted together on the top side 20. As illustrated in FIG. 1, frame segment 62 is the forwardmost segment and connects to middle segment 61 at flanged joints 53, 54, and 55. Frame segment 60 is the rearmost segment and connects to middle segment 61 at flanged joints 50, 51, and 52. The frame 11 may be provided in this segmented form for ease of transporting the frame 11.

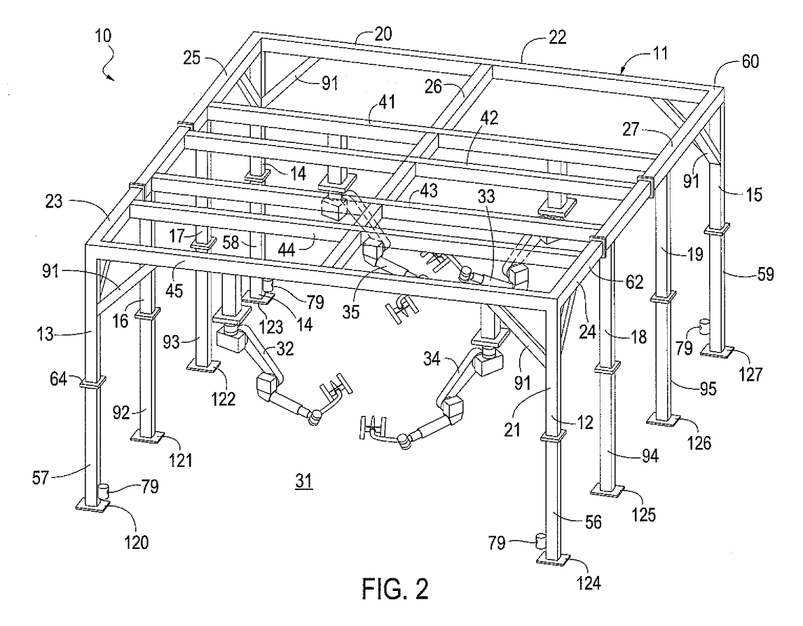

The frame 11 may further comprise corner lower leg members 56, 57, 58, and 59. The corner lower leg members 56-59 join to the frame posts 12-15, respectively at leg joints 63-66, respectively, as illustrated in FIG. 1, in order to extend the height of the frame 11, and provide for disassembly and shipment of the frame 11. Leg joints 63-66 comprise standard flanges bolted together. The corner lower leg members 56-59 may comprise lower flanges (not shown) and may be fastened to the floor 46 via standard bolts (not shown) to secure the frame 11 to the floor 46. Similarly, the plurality of vertical supports 16-19 may join to lower leg members (not shown) via flanged joints (not shown), which is described further with reference to FIG. 2.

The system 10 comprises several safety features for the protection of humans 67 in the test area 31. A safety wall 68 located outside of an open doorway 69 in the frame 11 protects the humans 67 from inadvertently entering the test area 31 and being injured. The safety wall 68 comprises a plurality of generally vertical support posts 70 and 71, a plurality of generally horizontal supports 72 and 73, and a blocking wall 74. The vertical support posts 70 and 71 and the horizontal supports 72 and 73 may be fabricated from any of a number of rigid materials, such as aluminum, steel, or composite material. The blocking wall 74 may be fabricated from any of a number of rigid materials such as fiberglass, plastic, composite, wood, fabric, or the like. The safety wall 68 is spaced apart from the left side 24 of the frame 11 so as to allow entry by humans 67 through the open doorway 69 into the test area 31 by walking around the safety wall 68, while preventing humans 67 from unknowingly running into the test area 31.

Four (4) safety “wings” 75-78 extend longitudinally from the four corner posts 12-15. The safety wings 75-78 are comprised of a rigid material and guard the front and rear sides 21 and 22 of the test area 31 from inadvertent entry by humans 67.

A plurality of motion detectors 79 (one of which is shown in FIG. 1) may be disposed on the lower leg members 56, 57, 58, and 59. The motion detectors 79 may be SIC scanners or other commonly known motion detectors. The motion detectors 79 detect motion by humans 67 within a parabolic area 80 outwardly from each detector 79. The motion detectors 79 may sound an audible and/or visible alarm (not shown) when they are triggered and may further automatically stop the robots 32-35 from moving to protect humans 79 who may have entered the test area 31 from injury.

A plurality of safety mats 81 disposed on the floor 46 in the test area 31 stop the movement of the robots 32-35 when stepped on by one or more humans 67. The safety mats 81 may ran longitudinally along the interior floors of the frame 11 in the areas where technicians (not shown) may be repairing or training the robots 32-35.

FIG. 2 further illustrates the embodiment of the system 10 shown in FIG. 1, and particularly the frame 11. Diagonal members 91 may be used to provide further support between the corner posts 12 and 13 and the frontmost horizontal support beam 45, for example, and the corner posts 14 and 15 and the rearmost horizontal support beam 40. Other diagonal supports (not shown) may also provide support to various components.

Frame components such as horizontal transverse support beam 45, vertical corner posts 12-15, and lower leg members 56-59, for example, may be substantially hollow and may comprise openings 90 for receiving cables (not shown) that power and control the robots 32-35 and the robot controllers 49. This allows the cables to be run inside of the frame components and thus out of the way of the way of operation of the system 10.

The frame 11 may further comprise central lower leg members 92, 93, 94, and 95. The central lower leg members 92-95 join to the vertical supports 16-19, respectively, at leg joints 96-99, respectively, as illustrated in FIG. 2, in order to extend the height of the frame 11, and provide for disassembly and shipment of the frame 11. Leg joints 96-99 comprise standard flanges bolted together.

In the embodiment depicted in FIG. 2, the central lower leg members 92-95 are coupled to flanges 121, 122 and 125, 126, respectively. Further, the corner lower leg members 56-59 are coupled to lower flanges 124, 120 and 123, 127, respectively. These flanges 121-127 may be fastened to the floor 46 via standard bolts (not shown) to secure the frame 11 to the floor 46.

Note that with reference to FIG. 2, the robots 32-35 may be mounted to any one of the members making up the frame 11. In FIG. 2, the robots 32-35 are shown attached to horizontal members 41 and 45 of the top side 20.

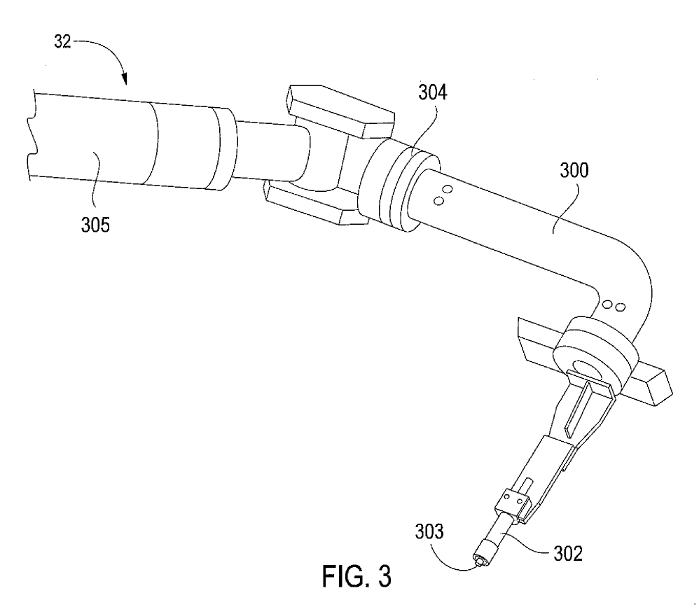

FIG. 3 depicts an exemplary robot 32. Note that while robot 32 is shown and described in more detail, each of the other robots 33-35 are substantially similar to and operate in a similar manner to robot 32. For brevity, only one of the robots is described in more detail.

The robot 32 comprises a robotic component 305 that movably couples to an end effector 300 via a mounting face 304. The end effector 300 comprises a housing 302. The housing 302 houses an ultrasound receiver 303. The ultrasound receiver 303 is communicatively coupled to one or more of the controllers 49 (FIG. 1).

In such an embodiment, the robot 32, via logic described further herein, moves the end effector 300 around a seal or a gap of a vehicle 36-38 (FIG. 1). Note that a gap with respect to the vehicle is a space where two components of the vehicle meet, but may not necessarily be noticeably sealed. Whereas a seal would be an intersection of two components of the vehicle and some type of seal is placed between them to ensure that air does not enter or escape from within the vehicle, e.g., the seal around a windshield of the vehicle. Further note that in one embodiment, the robotic component 305, in conjunction with the mounting face 304, can be moved in a number of different axes to ensure that the end effector 300 is directed along a particular seal in the automobile 36-38. The detector 303 detects ultrasound from one or more seals and/or gaps, and data indicative of the ultrasound detected is transmitted to the controller 49 for storage, analysis, and/or further manipulation.

The ultrasound receiver 303 disposed on the end effector 300 receives signals (not shown) from a transmitter (not shown) enclosed within a vehicle 37 (FIG. 1) under test. The ultrasonic receiver 303 may be any type of receiver known in the art and may include a means of amplification prior to transmission of data (not shown) received from a transmitter 111 (FIG. 6). The number and position of ultrasonic receivers 303 may vary depending upon the application. Thus, the number and position of the ultrasonic receivers 303 may vary in other embodiments of the present disclosure.

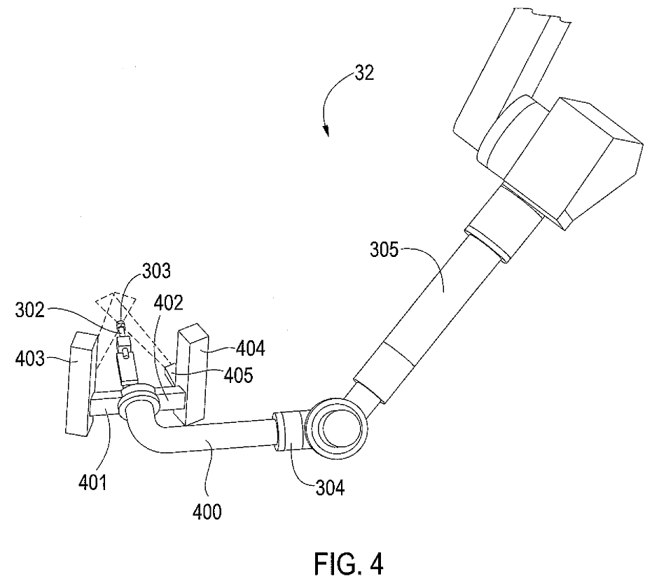

FIG. 4 depicts another exemplary embodiment of the robot 32. In such an embodiment, the robot 32 also comprises the robotic component 305. In such an embodiment, the robotic component 305 is coupled to an end effector 400 via the mounting face 304.

The end effector 400 comprises one or more cameras 403 and 404. The cameras 403 and 404 are disposed on one or more brackets 401 and 402, respectively. A light 405 may be disposed on the cameras 402 and 403. This light 405 provides a source of illumination of the areas being recorded by the cameras 403 and 404. In addition to the cameras 403 and 404, the end effector 400 also comprises the ultrasound receiver 303 within the housing 303.

During operation, the ultrasound receiver 303 collects ultrasound data related to seals of a vehicle 36-38 (FIG. 1), as described with reference to FIG. 3. In addition, however, each camera 403 and 404 illuminates the seal that is being tested. Based upon the images recorded, the controller 40 can triangulate mass, for example related to a gap between a front door of the vehicle and the back door of the vehicle, in order to determine whether the gap is flush, e.g., that the one side of the gap associated with the front door is even with the other side of the gap associated with the back door. Note that determining gap and flush via data obtained by the cameras 403 and 404 and the controller 49 may be performed with other gaps associated with a vehicle, e.g., the trunk, etc.

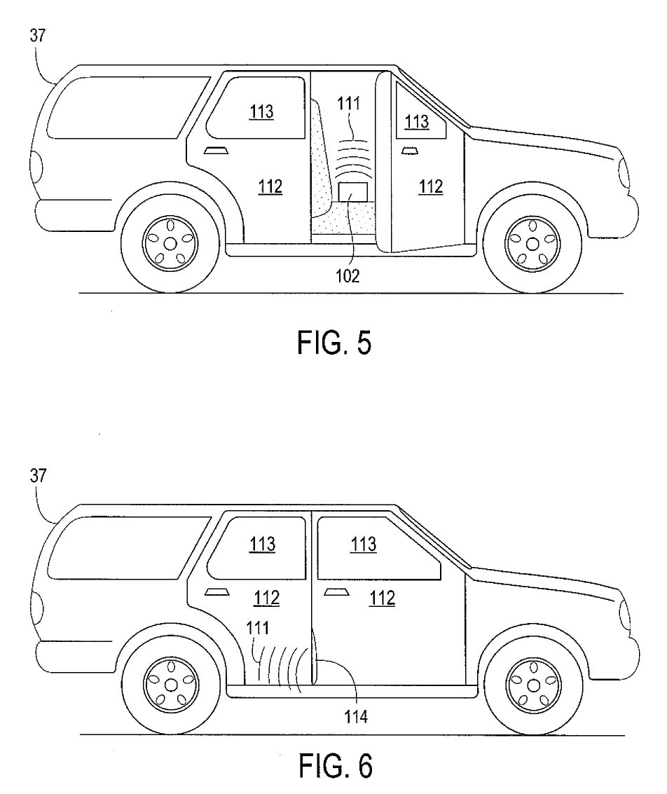

Referring to FIG. 5, during the leak test operation, a transmitter 102 is temporarily placed into the vehicle 37 for leak testing purposes. The transmitter 102 emits ultrasound energy 111. Referring to FIG. 6, when the doors 112 and windows 113 of the vehicle 37 are closed, ultrasound energy 111 may emit from one or more areas at which there are openings 114 through which the ultrasound energy may emit from the vehicle 37, such as a defective door seal (not shown). Other possible leakage paths include defective glass, welded areas, and the like (not shown).

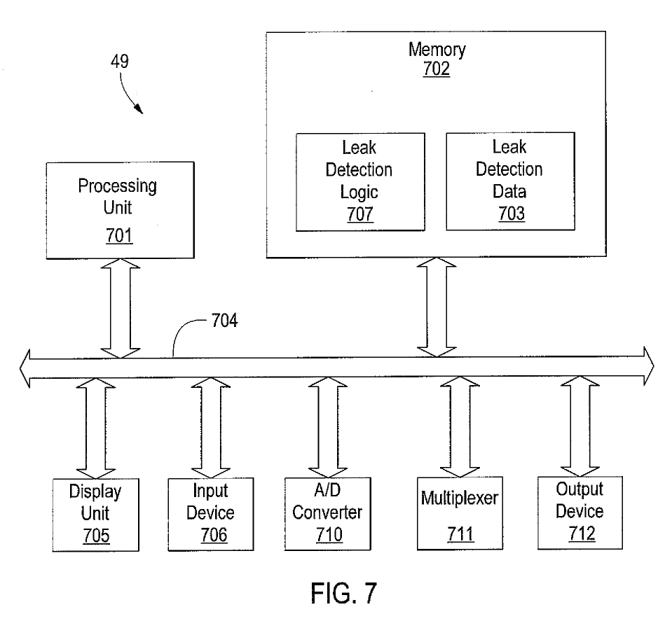

Notably, there may be normal emissions, i.e., areas on the vehicle through which ultrasound may emit, that would not indicate an abnormal leakage. Such normal emissions may be pre-determined and quantified and stored as an “acceptable” emissions signature. Such storage is described in more detail with reference to FIG. 7. However, there may also be abnormal emissions, i.e., areas on the vehicle through which ultrasound emits, that indicate an unanticipated leakage. Ascertainment of an abnormal emission may be obtained by comparing the real-time signature of the vehicle-under-test, e.g., vehicle 37, with the stored acceptable emissions signature.

Before a leak test of the vehicle 37 is performed, a technician (not shown) scans the vehicle identification (“VIN”) number of the vehicle 37 with a scanner (not shown) that is known in the art. The VIN number is uploaded to the robot controllers 49 and is used by the controllers 49 to control the robots 32-35 in the desired movement pattern for the specific vehicle 37 under test. In this regard, data indicative of how the robots are to move based upon the VIN has been pre-determined.

The vehicle 37 is driven into the test area 31 (FIG. 1) by a driver (not shown). The left wheels (not shown) of the vehicle 37 are received between the right guide 29 and the left guide 30 of the track 28 and the vehicle 37 is guided into correct orientation for testing by the track 28. The wheel stop (not shown) provides an indication to the driver that the vehicle 37 should be stopped, and the driver stops the vehicle 37 for the duration of the leak test.

The robots 32-35 are in a stowed configuration while the vehicle 37 enters and exits the test area 31, meaning that the robot arms (not shown) are out of the way of the entering or exiting vehicle 37. The cameras 403 and 404 (FIG. 4) record visual images of the vehicle 37 and send image data (not shown) the robot controllers 49. The robot controllers 49 process this image data and determine the orientation of the vehicle 37 with respect the receivers 303 (FIGS. 3 and 4) and the cameras 403 and 303. If the vehicle 37 is not in the proper orientation for testing within a predetermined tolerance according to the actual orientation of the vehicle 37, the robot controllers 49 adjust the position of the robot 35 to bring the receivers 303 and cameras 403 and 404 into the desired position with respect to the actual orientation of the vehicle 37. Note that adjustment of the robots 32-35 may be done initially prior to initiation of testing, or adjustments can be made dynamically in the movement of the robots 32-35 as readings are being taken.

The robots 32-35 then move the receivers 303 adjacent to the outside areas of the vehicle 37 in which unacceptable leakage may occur, such as the windows and/or door seals (not shown). The movement of the receivers 303 is controlled by the robot controllers 49. The receivers 303 detect ultrasound signals that may be emitted from the vehicle 37 when the transmitter 102 (FIG. 5) is placed within the vehicle 37. The receivers 303 generally move over the surface of the vehicle 37 at a predetermined speed (such as one foot per second, for example) with the receivers 303 spaced apart from the surface such that the receivers 303 do not contact the surface, but are in close proximity thereto.

The robot controllers 49 are communicatively coupled to the receivers 303. Such coupling may be effectuated by a hard-wire cable. In addition, the receivers 303 may be wirelessly coupled to the robot controllers 49. Communication between the robot controllers 49 and the receivers 303 may be effectuated in other ways known in the art in other embodiments.

The receivers 303 detect the ultrasound energy being emitted from the transmitter 102 (FIG. 5), and transmit data indicative of the ultrasound energy detected to the robot controllers 49, as described hereinabove. The data transmitted may be analog or digital data. In one embodiment, the data is analog, and the computing device may convert the analog data to digital data prior to analysis, storage, or display. In this regard, the robot controllers 49 may comprise an analog-to-digital (A/D) converter for such described conversion. In other embodiments, the data transmitted may be digital data, in which case such conversion may not be used.

FIG. 6 depicts an exemplary vehicle 37, for example a passenger automobile. The transmitter 102 (FIG. 5) is placed within the vehicle 37 when a door 112 of the vehicle 37 is in an open position. Once the transmitter 102 is placed in the vehicle 37, the door (not shown) is closed. When testing vehicles 37 such as passenger vans or sports utility vehicles (“SUVs”), such as the vehicle 37 illustrated in FIG. 6, a single transmitter 102 per vehicle under test may be sufficient. However, where the vehicle 37 is a sedan (not shown), for example, with a trunk compartment (not shown) that is separate from the passenger compartment (not shown), the transmitter 102 may be placed in both the trunk and the passenger compartments.

The exemplary transmitter 102 comprises one or more transducers (not shown). Each transducer produces and emits ultrasound energy 111. The ultrasound energy 111 travels outwardly from the transmitter 102 within the vehicle 37. In this regard, if there are openings, e.g., cracks or improperly installed seals (not shown), in the vehicle 37, the ultrasound energy 111 will escape from those openings in the vehicle 37 in amounts that are detectable by the receivers. Note that it is possible that some level of ultrasound energy 111 will normally escape from the vehicle 37. However abnormal changes from the normal level of ultrasound energy 111 may indicate unacceptable leakage.

The receivers 303 sample the ultrasound energy 111 emitted from the vehicle 37 as the receivers 303 move in a predetermined pattern and speed over the outside surface of the vehicle 37. As the receivers 303 receive the ultrasound energy 111, the receivers 303 transmit data indicative of the received energy to the robot controllers 49. When the receivers 303 have completed their circuit of sampling the exterior areas of the vehicle 37 as controlled by the robot controllers 49, the robots 32-35 return to a stowed orientation.

FIG. 7 depicts an exemplary robot controller 49 of the present disclosure. The exemplary robot controller 49 generally comprises a processing unit 701, a display unit 705, an output device 712, and an input device 706.

The display unit 705 is any type of device, for example a printer or a monitor, which displays data to a user (not shown). The data may be displayed in the form of a graphical user interface (GUI), for example. The display unit 705 may display, as an example, a graphical depiction of the vehicle-under-test, i.e., the vehicle 37 (FIG. 1). If data received indicates that there is more or less ultrasound energy being emitted from the vehicle 37, the graphical depiction may indicate where on the vehicle 37 the energy is being emitted.

The robot controller 49 further comprises leak detection logic 707 and leak detection data 703, which can be software, hardware, or a combination thereof. In the exemplary robot controller 49, leak detection logic 707 and a leak detection data 703 are shown as stored in memory 702.

The processing unit 701 may be a digital processor or other type of circuitry configured to run the leak detection logic 707 by processing and executing the instructions of the leak detection logic 707. The processing unit 702 communicates to and drives the other elements within the robot controller 49 via a local interface 704, which can include one or more buses.

Furthermore, an input device 706, for example, a keyboard, a switch, a mouse, and/or other type of interface, can be used to input data from a user of the robot controller 49, for example, a user (not shown) may use the input device 706 to control the receivers 303, lights 405 and cameras 403 and 404 (FIG. 4), perform setup operations on the receivers 303 or the system as a whole, to select preferences for the system 10 and the like. In addition, the input device 706 may comprise a scanner (not shown) for scanning the VIN number of the vehicle 37.

In addition, an output device 712, for example, a universal serial bus (USB) port or other type network device connects the robot controller 49 with a network (not shown) for communication with other network devices (not shown). In addition, the output device 712 may connect the robot controller 49 with the receivers 303, lights 405 and/or cameras 403 and 404.

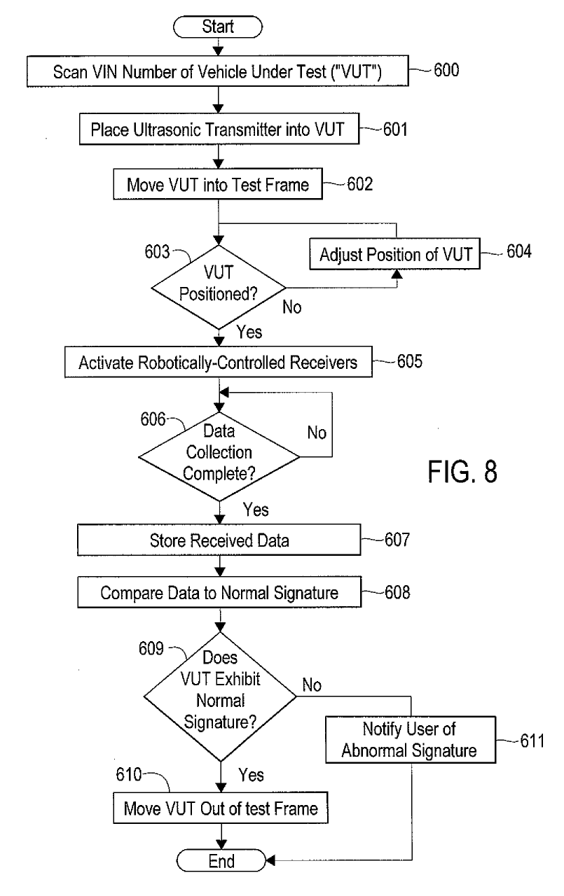

In the exemplary robot controller 49 of FIG. 8, the leak detection logic 707 and the leak detection data 703 are shown, as indicated hereinabove, as being implemented in software and stored in memory 702. However, the leak detection logic 707 and the leak detection data 703 may be implemented in hardware, software, or a combination of hardware and software in other embodiments.

When stored in memory 702, the leak detection logic 707 and the leak detection data 403 can be stored and transported on any computer readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The robot controller 49 may further comprise an A/D converter 710 and a multiplexer 711. Notably, if the receivers 303 (FIG. 3) transmit an analog signal, prior to data analysis or use, the A/D converter 710 converts the received signal to a digital signal. Such conversion is known in the art. In addition, the plurality of signals received from the receivers 303 may be converted to a single signal by the multiplexer 711. Such conversion leads to more effective processing of the received data and more precise analysis of the data received.

The leak detection data 703 comprises data indicative of a normal ultrasound emission signature of the vehicle 37 (FIG. 1). In this regard, the signature may comprise a grid of normalized values indicative of the “normal” emissions of an acceptable vehicle of the type under test. In addition, the leak detection data 703 comprises data indicative of the real-time data received from the receivers 303 related to the vehicle 37 that is under test. Note that the format of the data of the normal signature and the format of the data indicative of the real-time data received is in a substantially similar or identical format so that an informative comparison can be obtained.

The leak detection logic 707 may perform a plurality of functions. As an example, the leak detection logic 707 may convert the received data into a format for comparison to the normal signature. In addition, if the comparison indicates an abnormal signature of the vehicle 37 that is under test, the leak detection logic 707 may alert a user (not shown), via the display device 705 that the vehicle 37 has an abnormal leak. The leak detection logic 707 may further store data that can be used in the future to identify areas in manufacture that may need to be addressed.

As an example, on a particular assembly line the data stored may indicate that a number of vehicle 37 fail the leak test around the door 112 (FIGS. 5 and 6). In such an example, that station of the line responsible for installing the seal around the door 112 may be scrutinized to determine if the process being used for installation is ineffective.

Note that the robot controller 49 is shown as a separate device from the receivers 303, the cameras 403 and 404 and the lights 405. Structurally, however, such depiction is for explanatory purposes only. The robot controller 49 and/or the receivers 303 and/or the camera 403 and 404 and or the light 405 may be a single unit. In addition, the robot controller 49 may not be a single unit, but may comprise a number of devices.

FIG. 8 is a flowchart depicting exemplary architecture and functionality of a system 10 (FIG. 1) of the present disclosure. For purposes of the following exemplary architecture and functionality, it is assumed that the robot controllers 49 (FIG. 1) control operation of the robots 32-35 (FIG. 1) the receivers 303 (FIG. 3), the cameras 403 and 404 (FIG. 4) and the lights 405 (FIG. 4) via the leak detection logic 707 (FIG. 7). However, the receivers 303 and/or the cameras 403 and 404 and/or the lights 405 may comprise a separate control apart from the robot controllers 49 that receive data (not shown) from the receiver 303.

During operation, a technician (not shown) scans the VIN number of the vehicle 37, in accordance with step 600. The technician also places the transmitter 102 (FIG. 6) into the vehicle 37, in accordance with step 601, and closes the vehicle doors and window. A driver (not shown) moves the vehicle 37 under test into the test area 31 (FIG. 1) in step 602. Alternatively, the vehicle 37 may be moved into position on a conveyor (not shown) of the type that can be found in a standard automobile assembly line. The leak detection logic 707 (FIG. 7) receives a signal from the camera 403 and/or 404 (FIG. 4) identifying the orientation of the vehicle 37, and the leak detection logic 707 determines whether the vehicle 37 is in the proper position for testing, in accordance with step 603. If the vehicle 37 not within a predetermined tolerance of the required position for testing, the leak detection logic 707 sends a signal informing the user (not shown) that the vehicle needs to be repositioned, in accordance with step 604. Thus until a signal is received indicating that the vehicle 37 is in the proper position, the system 10 remains idle with the robots 32-35 in a stowed orientation. If the vehicle 37 is within the predetermined tolerance of the required position for testing, the leak detection logic 707 activates the robots 32-35 to begin their test sequence and activates the receivers 303 and cameras 403 (FIG. 4) and 404 (FIG. 4) to begin collecting data, in accordance with step 605. The leak test logic 707 automatically corrects the positioning of the robots 32-35 for mismatches in vehicle 37 position provided that the position is within the predetermined tolerance.

Once data collection is complete in step 606, the leak detection logic 707 stores data indicative of the received ultrasound energy 111 (FIG. 5) and the images retrieved by the cameras 403 and 404 in memory 702 (FIG. 7), as indicated in step 607. The leak detection logic 707 compares the received data to a normal ultrasound signature of the vehicle 37 that is under test and triangulates the data received from the cameras 403 and 404, as indicated in step 608. If the vehicle 37 exhibits a normal signature and there is not an abnormal gap, as indicated in step 609, then the leak detection logic 707 provides an indication that the test has been completed successfully, and the vehicle 37 may be moved out of the test area, per step 610. If the comparison indicates that the vehicle has an abnormal ultrasound emission signature or abnormal gap in step 609, the leak detection logic 707 notifies the user of an abnormal signature, in accordance with step 611.

Note that notification can come in a variety of forms. For example, the leak detection logic 707 may store data indicative of an abnormal signature for the vehicle 37 that is under test then continue the assembly line process. On the other hand, the leak detection logic 407 may initiate a real-time alert via a horn (not shown), a light (not shown) or a change in the display device 705 (FIG. 7).

1. A system, comprising:
an extended tunnel for receiving a vehicle;
at least one robot disposed within the extended tunnel, the robot comprising an ultrasound receiver and a camera;
logic configured to move the robot in a direction that places the ultrasound receiver and the camera in proximity with a seal or a gap.

2. The system of claim 1, wherein the extended tunnel is a frame and the top side of the frame comprises one or more segments coupled together via one or more flanges.

3. The system of claim 2, wherein the extended tunnel further comprises one or more extension legs coupled to the one or more segments and extending the height of the extended tunnel.

4. The system of claim 3, wherein each of the segments comprises one or more longitudinal members and one or more lateral members.

5. The system of claim 4, wherein the at least one robot is coupled to one of the longitudinal members.

6. The system of claim 4, wherein the at least one robot is coupled to one of the lateral members

7. The system of claim 1, wherein the logic is further configured to receive ultrasound data indicative of ultrasound detected by the ultrasound receiver.

8. The system of claim 7, wherein the logic is further configured to determine, based upon the ultrasound data if leakage from the seal or the gap in the vehicle exceeds a pre-determined leakage threshold.

9. The system of claim 1, wherein the logic is further configured to receive image data from the camera.

10. The system of claim 9, wherein the logic is further configured to determine, based upon the image data, if a gap in the vehicle under test is sufficiently flush.

11. The system of claim 10, wherein the logic determines if the gap is sufficiently flush based upon triangulation.

12. The system of claim 1, wherein the logic is configured to simultaneously collect ultrasound data from the receiver and image data from the camera.

13. A method, comprising:
moving a vehicle through an extended tunnel;
moving an ultrasound receiver and a camera within proximity of a seal or a gap in the vehicle along a predetermined path.

14. The method of claim 13, further comprising receiving ultrasound data indicative of ultrasound detected by the ultrasound receiver.

15. The method of claim 14, further comprising determining, based upon the ultrasound data, if leakage from the seal or the gap in the vehicle under test exceeds a pre-determined leakage threshold.

16. The method of claim 13, further comprising receiving image data from the camera.

17. The method of claim 16, further comprising the step of determining, based upon the image data, if the gap in the vehicle under test is sufficiently flush.

18. The method of claim 17, further comprising the step of determining if the gap is sufficiently flush based upon triangulation.

19. The system of claim 1, further comprising simultaneously collecting ultrasound data from the receiver and image data from the camera for the seal or gap.

20. A method comprising:
scanning a vehicle identification number of a vehicle under test;
placing an ultrasonic transmitter into the vehicle under test;
moving the vehicle under test into a test frame;
verifying a proper orientation of the vehicle for testing;
activating robotically-controlled ultrasonic receivers;
collecting leak test data;
storing leak test data received from the ultrasonic receivers; and
comparing the leak test data received to a normal leak test signature.
